(19) United States
(12) Patent Application Publication
(10) Pub. No.: US 2020/0180707 A1
(43) Pub. Date: Jun. 11, 2020

(54) PICKUP TRUCK LIFT GATE ACCESSORY

(71) Applicant: Ford Global Technologies, LLC, Dearborn, MI (US)

(72) Inventors: Aaron Bradley Johnson, Allen Park, MI (US); Thomas William Partch, Trenton, MI (US); Brian Kenneth Sullivan, Plymouth, MI (US); Stephen Kenneth Helwig, Farmington Hills, MI (US); Joshua Robert Hemphill, White Lake, MI (US)

(21) Appl. No.: 16/216,123

(22) Filed: Dec. 11, 2018

(51) Int. Cl. B62D 33/027; B60P 3/14; B62D 33/03

(52) U.S. Cl. CPC B62D 33/0273; B62D 33/03; B60P 3/14

(57) ABSTRACT

A disclosed tailgate accessory assembly includes an accessory body portion and a mount portion. The accessory body portion can include features that provide additional storage space, work surfaces or cargo securement features. The mount portion includes a first post spaced a distance from a second post, wherein each of the first post and the second post are configured for insertion into corresponding openings in a tailgate. A clip is provided for engaging a portion of the tailgate in a locked position for holding the accessory body portion to the tailgate.

### TECHNICAL FIELD

This disclosure relates to accessory structures that attach to a lift gate of a pickup truck.

### BACKGROUND

Vehicle manufacturers and, particularly, manufacturers of pickup trucks are continually looking for ways to improve vehicle utility. Pickup trucks include a cargo area with a tailgate that opens and closes. The tailgate is intended to simply provide access to the cargo area of the pickup truck. However, the tailgate has taken on many additional functions including a seat, a makeshift work area along with any other functions that a flat horizontal surface can provide in a remote location. Vehicle manufacturers have recognized such alternative uses for the tailgate and incorporated features that further increase its utility. One such improvement includes the addition of pockets to enable a clamp be utilized with a surface the tailgate to hold items that are being worked.

Pickup truck manufacturers are continually searching for features to that increase customer satisfaction, interest and loyalty.

### SUMMARY

A tailgate accessory assembly according to an exemplary aspect of the present disclosure includes, among other things, an accessory body portion, a first post spaced a distance from a second post, wherein each of the first post and the second post are configured for insertion into corresponding openings in a tailgate, and a clip for engaging a portion of the tailgate in a locked position for holding the accessory body portion to the tailgate.

In a further non-limiting embodiment of the foregoing tailgate accessory assembly, a mount portion attached to the body portion and the first post and the second post extend from the mount portion, the mount portion abutting a surface of the tailgate when the clip is in the locked position.

In a further non-limiting embodiment of any of the foregoing tailgate accessory assemblies, the first post and the second post are identically shaped.

In a further non-limiting embodiment of any of the foregoing tailgate accessory assemblies, the first post and the second post are disposed within a common plane.

In a further non-limiting embodiment of any of the foregoing tailgate accessory assemblies, the clip comprises a first clip disposed adjacent the first post and a second clip disposed adjacent the second post.

In a further non-limiting embodiment of any of the foregoing tailgate accessory assemblies, an electrical connector provides a connection to a power source.

In a further non-limiting embodiment of any of the foregoing tailgate accessory assemblies, the accessory body portion comprises a storage box including an interior space covered by a lid.

In a further non-limiting embodiment of any of the foregoing tailgate accessory assemblies, the mount portion is disposed transverse to the storage box such that the storage box rests on an inside surface of the tailgate.

In a further non-limiting embodiment of any of the foregoing tailgate accessory assemblies, the accessory body portion comprises a storage container with a closeable lid, the closeable lid including one of a high persistent phosphor warning sign or an illuminable warning sign.

In a further non-limiting embodiment of any of the foregoing tailgate accessory assemblies, the accessory body portion comprises an ice chest having a compartment for ice.

In a further non-limiting embodiment of any of the foregoing tailgate accessory assemblies, the first post and the second post extend outward transverse to the compartment for supporting the ice chest with the tailgate in a closed position.

In a further non-limiting embodiment of any of the foregoing tailgate accessory assemblies, the first post and the second post extend outward parallel to the compartment for supporting the ice chest with the tailgate in an opened position.

In a further non-limiting embodiment of any of the foregoing tailgate accessory assemblies, the ice chest includes a shelf extending from an outer surface of the compartment.

In a further non-limiting embodiment of any of the foregoing tailgate accessory assemblies, including cup holders that are supported within the compartment.

In a further non-limiting embodiment of any of the foregoing tailgate accessory assemblies, including a cooling assembly for cooling the compartment, the cooling assembly powered by an electrical connection to a power source.

In a further non-limiting embodiment of any of the foregoing tailgate accessory assemblies, the accessory body portion comprises a work table extending outward from the tailgate, the work table including a support member, an electrical power outlet and light source connectable to a power source.

In a further non-limiting embodiment of any of the foregoing tailgate accessory assemblies, the accessory body portion comprise a bike rack for securing a bike to the tailgate.

In a further non-limiting embodiment of any of the foregoing tailgate accessory assemblies, the bike rack includes a post for securement of a portion of a bike.

In a further non-limiting embodiment of any of the foregoing tailgate accessory assemblies, wherein the post extends upward from a top surface of the tailgate when the tailgate is in a closed position.

In a further non-limiting embodiment of any of the foregoing tailgate accessory assemblies, wherein the post extends transversely from an inner surface of the tailgate when the tailgate is in a closed position.

The various features and advantages of this disclosure will become apparent to those skilled in the art from the following detailed description. The drawings that accompany the detailed description can be briefly described as follows.

### BRIEF DESCRIPTION OF THE DRAWINGS

FIG. 1 is a perspective view of a cargo area and tailgate of a pickup truck.

FIG. 2 is a perspective view of a tailgate for a pickup truck.

FIG. 3 is a perspective view of a clamp pocket disposed in the tailgate.

FIG. 4 is a perspective view of a storage box accessory mounted to a tailgate.

FIG. 5 is a schematic view of a mount portion for the storage box accessory.

FIG. 6 is a cross-sectional view of the storage box accessory mounted to the example tailgate.

FIG. 7 is an enlarged cross-sectional view of the mount portion of the storage box accessory mounted to the tailgate.

FIG. 8 is a perspective view of a work table attached to the tailgate.

FIG. 9 is a cross-sectional view of the table mounted to the tailgate.

FIG. 10 is a perspective view of an ice chest attached to a top surface of a tailgate.

FIG. 11 is a cross-sectional view of the ice chest attached to the tailgate.

FIG. 12 is another ice chest attached to a tailgate.

FIG. 13 is a cross-sectional view of the ice chest attached to the tailgate.

FIG. 14 is a cross-section of the ice chest attached to the tailgate in a closed position.

FIG. 15 is a cross-sectional view of the ice chest attached to the tailgate in an open position.

FIG. 16 is a perspective view of a bike rack attached to a top surface of the tailgate in a closed position.

FIG. 17 is a cross-sectional view of the bike rack attached to the tailgate in the closed position.

FIG. 18 is a side view of another bike rack attached to the tailgate in the closed position.

FIG. 19 is a cross-sectional view of the bike rack attached to the tailgate in the closed position.

FIG. 20 is a perspective view of another tailgate of another bike rack attached to the tailgate in the closed position.

### DETAILED DESCRIPTION

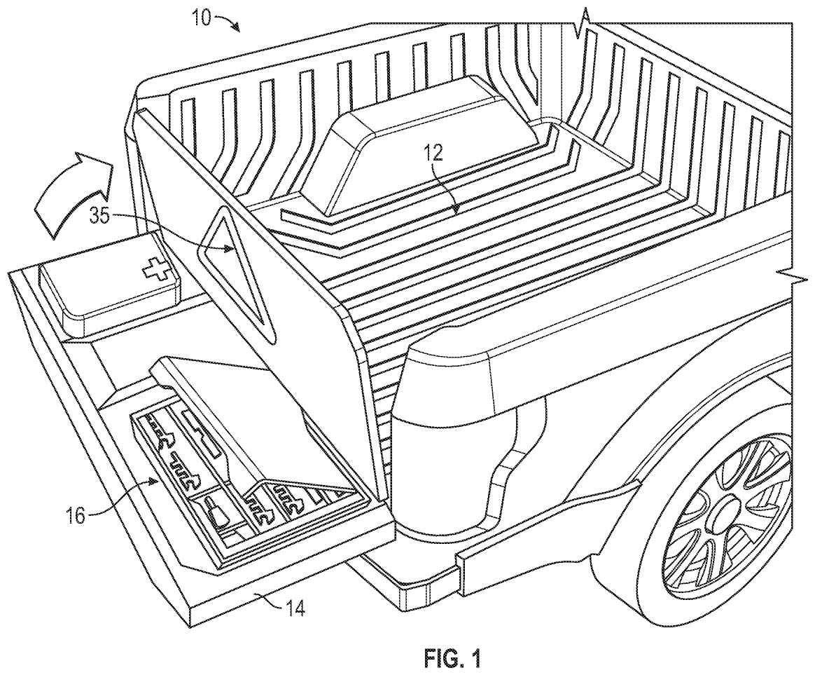

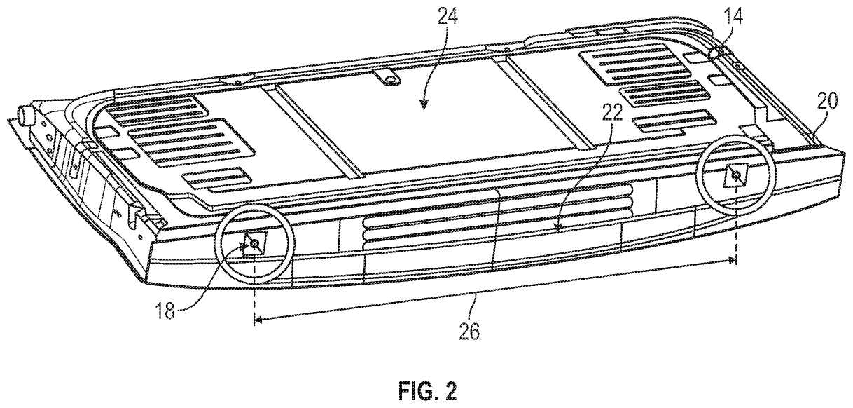

Referring to FIGS. 1 and 2, a pickup truck 10 includes a cargo area 12 and a closeable a tailgate 14. The tailgate 14 is moveable from an open position shown in FIG. 1 to a closed position. In the open position, the tailgate 14 provides a horizontal surface 24 that is commonly utilized in many different ways. The example tailgate 14 includes clamp pockets 18 and 20 that are spaced apart a horizontal distance 26. The distance 26 is common for all tailgates 14 and provides an opening for a clamp utilized to secure a work piece on the horizontal surface 24 of the tailgate 14. The clamp pockets 18, 20 are provided on a top surface 22 of the tailgate 14. The top surface 22 in this disclosure refers to the top most surface when the tailgate 14 is in a closed position.

The tailgate 14, in the example disclosed embodiment, includes an accessory item 16 that is attached to the tailgate 14 by way of the clamp pockets 18, 20. In this example, the accessory item 16 is a roadside emergency kit including a storage compartment with features for organizing tools and other useful items. The storage container includes a lid with an illuminable hazard triangle 35. The accessory item 16 is mountable within the clamp pockets also referred to as openings 18, 20 in this disclosure.

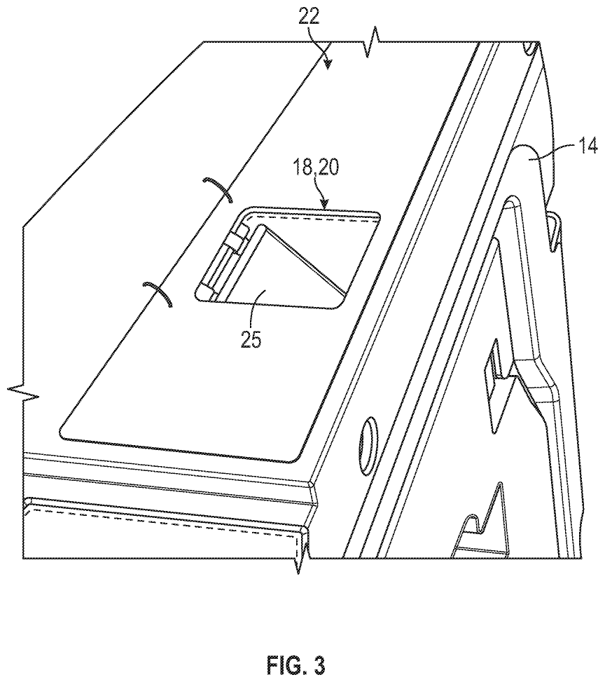

Referring to FIG. 3, with continued reference to FIGS. 1 and 2, one of the example openings 18, 20 includes a spring-loaded door 25. In this example, each of the clamp pockets 18, 20 are identical and, therefore only one is shown by way of example. In this example, each of the clamp pockets 18, 20 is a square opening with a spring-loaded panel 25 to prevent debris from collecting within the openings 18, 20. It should be appreciated that although a square opening is disclosed by way of example, other opening shapes including round or rectangular could be utilized and are within the contemplation of this disclosure.

The openings 18, 20 are set a standard distance 26 apart and the example disclosed accessory items are configured to fit the standard distance 26. In one disclosed example, the distance 26 is determined to a center of each clamp pocket 18, 20 and is between 43.0 and 45.0 inches (1092 mm and 1143 mm) from each other within applicable manufacturing tolerances. Moreover, other distances between pockets 18, 20 are within the scope and contemplation of this disclosure.

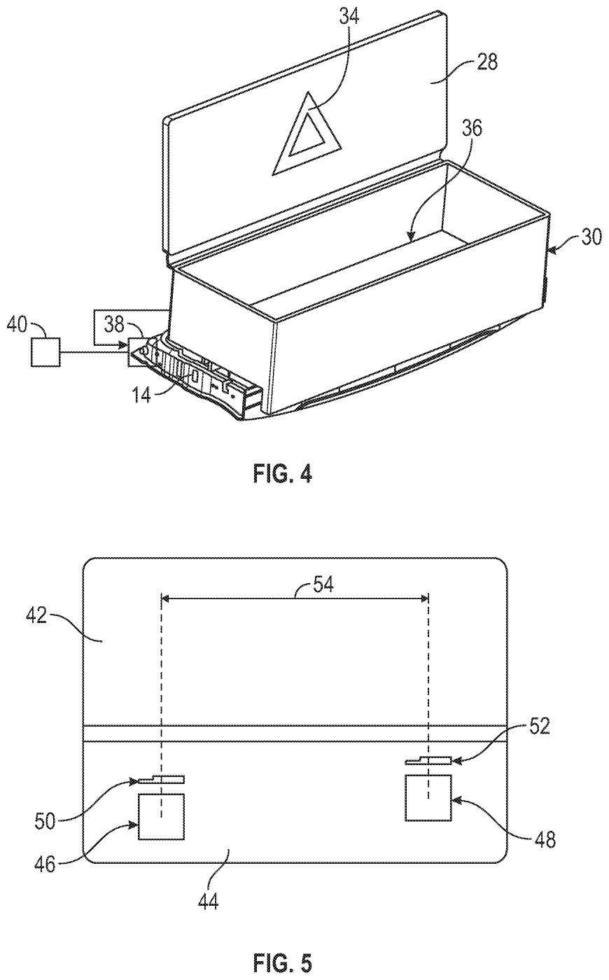

Referring to FIGS. 4 and 5, a disclosed example accessory item is a storage box 30. The example storage box 30 includes an inner compartment 36 and a closeable lid 28. The closeable lid 28 can include the hazard sign 34 that is viewable from the rear of the vehicle and can be utilized to warn drivers. The hazard sign 34 can be a high persistent phosphor or an electrically powered lighting element such as a light emitting diode.

Referring to FIG. 5, with continued reference to FIGS. 1-4, a mount portion 44 is schematically illustrated that includes a first clamp post 46 and a second post 48. The mount portion 44 is part of an accessory body portion 42 that comprises the different configurations of the disclosed accessory items. The first post 46 is spaced apart from the second post 48 a distance 54. The distance 54 between the first post 46 and the second post 48 corresponds with the distance 26 between the first opening 18 and the second opening 20. Accordingly, the mount portion 44 is a standard configuration for each accessory item that corresponds with the openings 18, 20 spaced apart the distance 26 deployed in the tailgate 14. Also provided on the mount portion 44 are clips 50 and 52. A first clip 50 and a second clip 52 provided on the mount portion 44 to maintain and hold the accessory item to the tailgate 14 once the first post 46 and the second post 48 are inserted therein. The clips 50, 52 can includes bendable element that engages a groove in the tailgate 14. The clips 50, 52 may also include a spring loaded member that fits within slot a slot of the tailgate 14 to secure the accessory item.

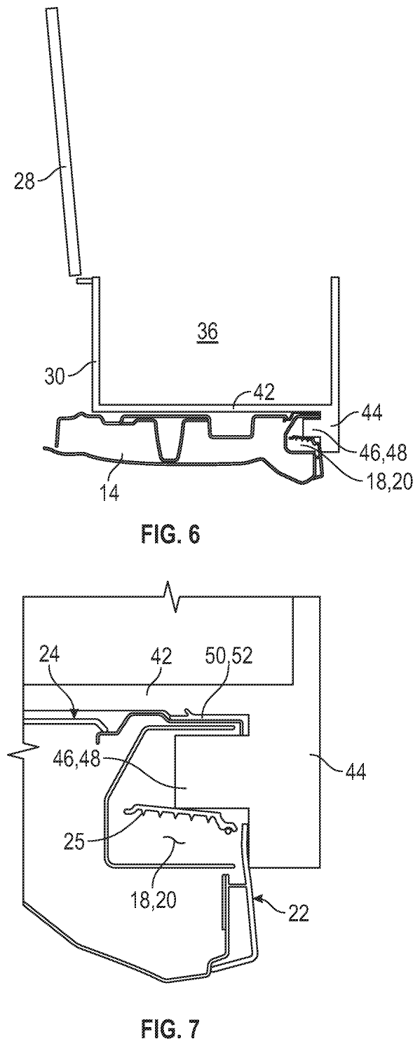

Referring to FIGS. 6 and 7, with continued reference to FIGS. 4 and 5, the example storage container 30 is shown mounted to the tailgate 14 in a cross-section. When the storage container 30 is mounted to the tailgate 14, the posts 46 and 48 are disposed within corresponding openings 18, 20. Each of the panel doors 25 are spring-loaded and opened by way of insertion of the first post 46 and second post 48. In this example, the storage box 30 rests along the horizontal inner surface 24 of the tailgate 14. One of the clips 50, 52 disposed on the tailgate 14 or on the mount portion 44 engages features engaged with one another to hold the accessory item to the tailgate 14.

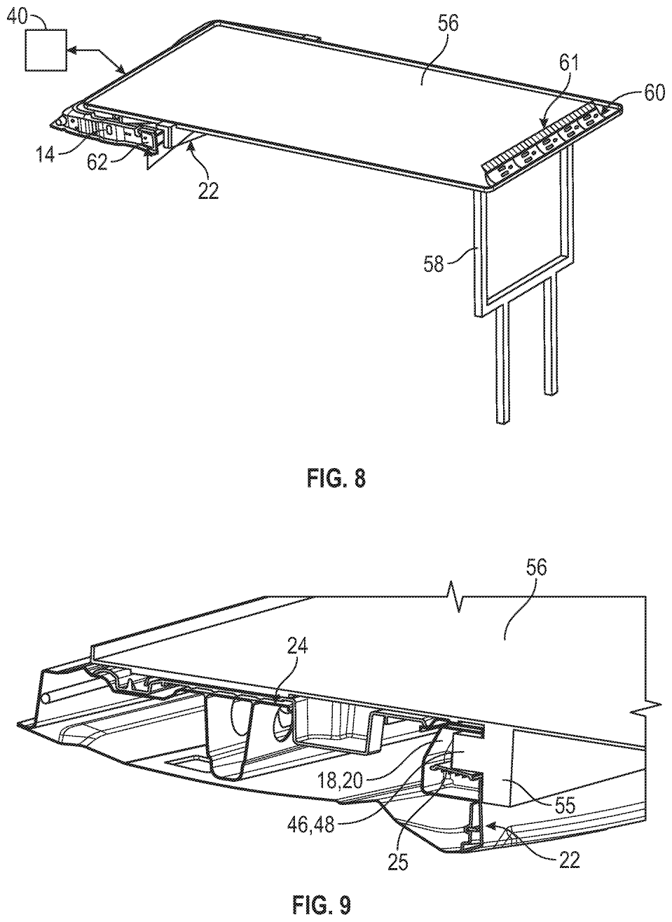

Referring to FIGS. 8 and 9, another disclosed accessory item is embodied as a table 56 that mounts to the tailgate 14. The table 56 includes mount portion 55 with posts 46 and 48 that are received within the openings 18 and 20 within the tailgate 14. The example table 56 extends outward horizontally from the tailgate 14 and includes legs 58 that support a distal end. In this example, the legs 58 can be folded upward into a storage position to enable easy storage and movement of the table 56. The table 56 also includes a power strip 60 and LED light bar 61 that is connected to a power source 40 of the vehicle. The light bar 61 in one disclosed embodiment is a direct LED system. The light bar 61 in another disclosed embodiment is an indirect LED system that utilizes a light pipe. The light bar 61 may include RGB LED such that colors cycle through different colors. Moreover, the light bar 61 may include LED that generate only a white light. The connection between the table 56 and the power source 40 is facilitated by an electrical connection within the tailgate 14. The electrical connection is schematically shown at 62 and may be of any configuration utilized with motor vehicles. The electrical connection can be disposed within one of the pockets 18 and 20 and correspond with one of the posts 46 and 48. The electrical connection may also be separate from the posts 46, 48 and connect to another location separate from the openings 18, 20 in the tailgate 14.

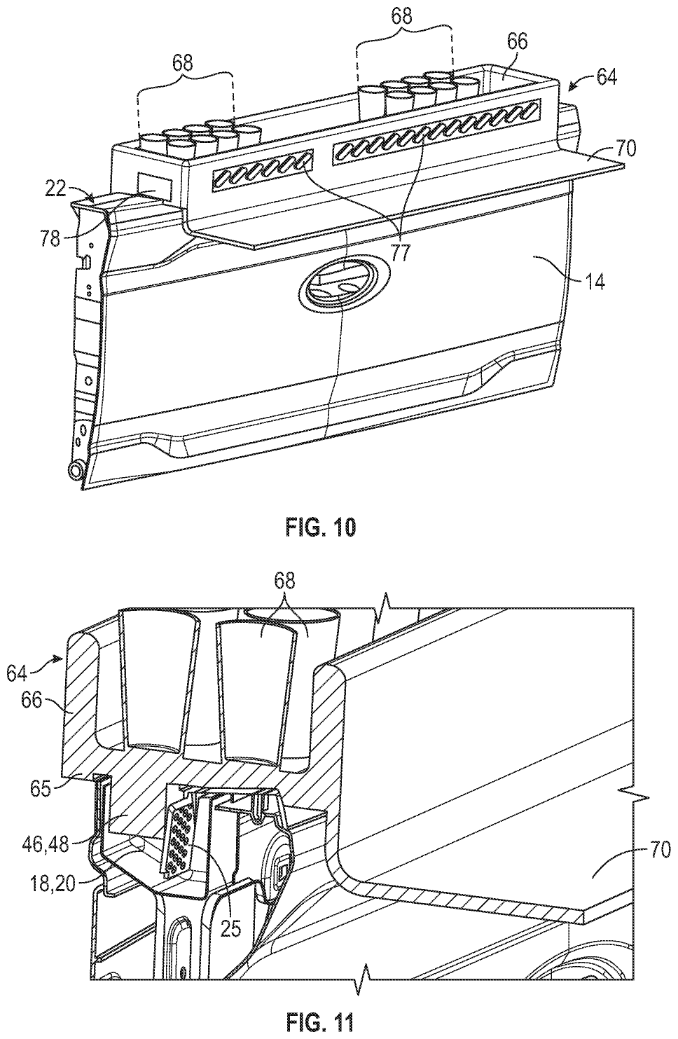

Referring to FIGS. 10 and 11, another example accessory item is schematically illustrated in FIGS. 10 and 11 and is an ice chest 64. The ice chest 64 is mountable to the tailgate 14 on the top surface 22. The ice chest provides a container 66 for ice or other items along with a cup holder 68. The compartment 66 includes a mount portion 65 from which the posts 46 and 48 extend. It should be appreciated that throughout this disclosure that the mount portion is described as including posts 46 and 48. Each of the posts 46 and 48 of each disclosed mount portion are of a common design and spaced apart a common distance to correspond with the openings within the tailgate 14. While different configurations of the mount portion 65 are described by way of example in this disclosure, each mount portion includes the same posts 46 and 48 that are spaced the same distance 54 apart to correspond with the distance 26 between openings 18, 20 within the tailgate 14.

The ice chest 64 includes cup holders 68 that are removable from the interior compartment 66 as desired. The interior compartment 66 is intended to hold ice, to provide cooling for beverages, and to sit atop the tailgate 14 to provide a convenient location for accessing beverages. The example ice chest 64 also includes a shelf 70 that provides further utility for the tailgate when being used in a said beverage holder.

The example ice chest 64 may also include an electrical connection 78 that enables powering of a cooling device, shown schematically at 77, to maintain a desired temperature within the compartment 66 to maintain beverages at the desired temperature. The electrical connection 78 and cooling device 77 may be of any configuration understood and known by those skilled in the art.

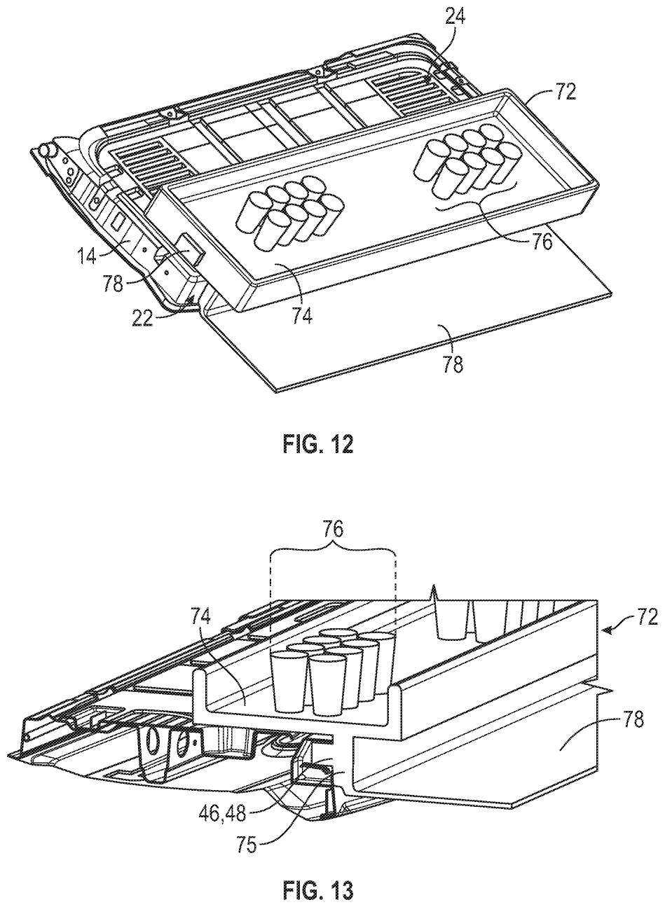

Referring to FIGS. 12 and 13, another example cooling chest 72 includes a mount portion 75 with posts 46 and 48. The example ice chest 72 includes a container portion 74 for ice, beverage or food items. The ice chest 72 is mountable to the tailgate 14 when the tailgate 14 is in an open position such that the interior surface 24 is horizontal and the top surface 22 extends substantially vertically. In this example, the ice chest 72 engages the openings 18 and 20 of the tailgate 14 to hold the ice chest 72 in the tailgate 14 when in the open position.

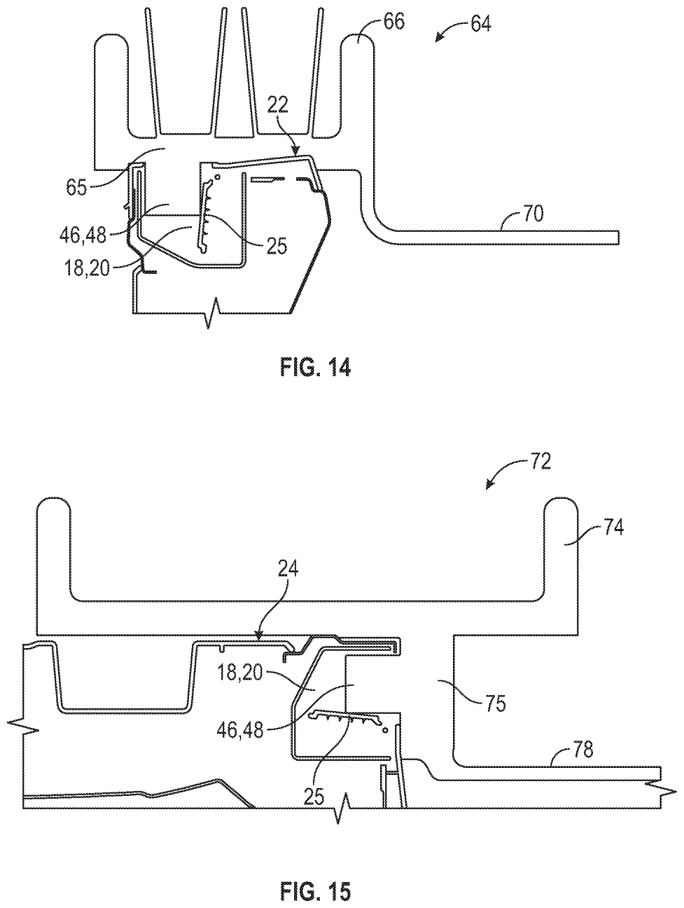

Referring to FIGS. 14 and 15, with continued reference to FIGS. 10-13, the example ice chests 64 and 72 are shown in cross-section to illustrate the posts 46 and 48 that engage the openings 18 and 20 of the tailgate 14. Although each of the ice chests 64 and 72 have a different configuration that correspond with the orientation of the tailgate 14, each has a mount portion 76, 75 that includes commonly shaped and sized posts 46 and 48 that are spaced apart the distance 54 that correspond with the pocket features 18 and 20 within a tailgate 14.

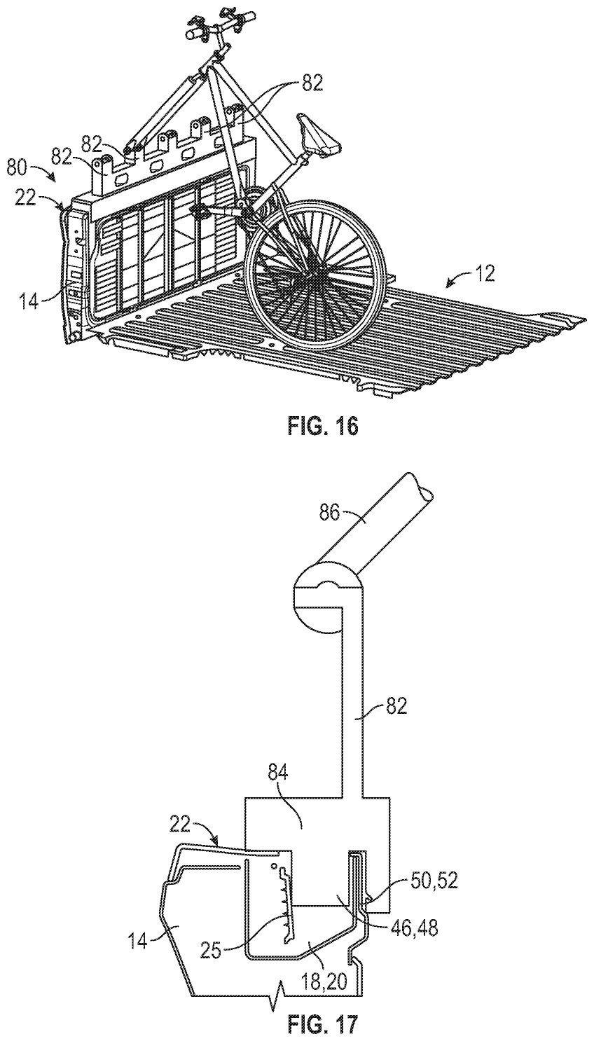

Referring to FIGS. 16 and 17, another example accessory component is a bike rack 80 that includes post 82 for securing a bike within the cargo area 12. The example bike rack 80 attaches to the top surface 22 of the tailgate 14 and includes post 82 that are provide for securement of a portion of the bike. In this example, the front fork 86 is secured to each post 82. The example bike rack 80 includes multiple posts 82 to enable transport of multiple bikes. The example bike rack 80 includes a mount portion 84 having the posts 46 and 48. The posts 46 and 48 are configured to be received within the openings 18 and 20 defined within the tailgate 14. In this example, the bike rack 80 includes the posts 82 that are configured to extend upward from the mount portion 84 and the top surface of the tailgate 14.

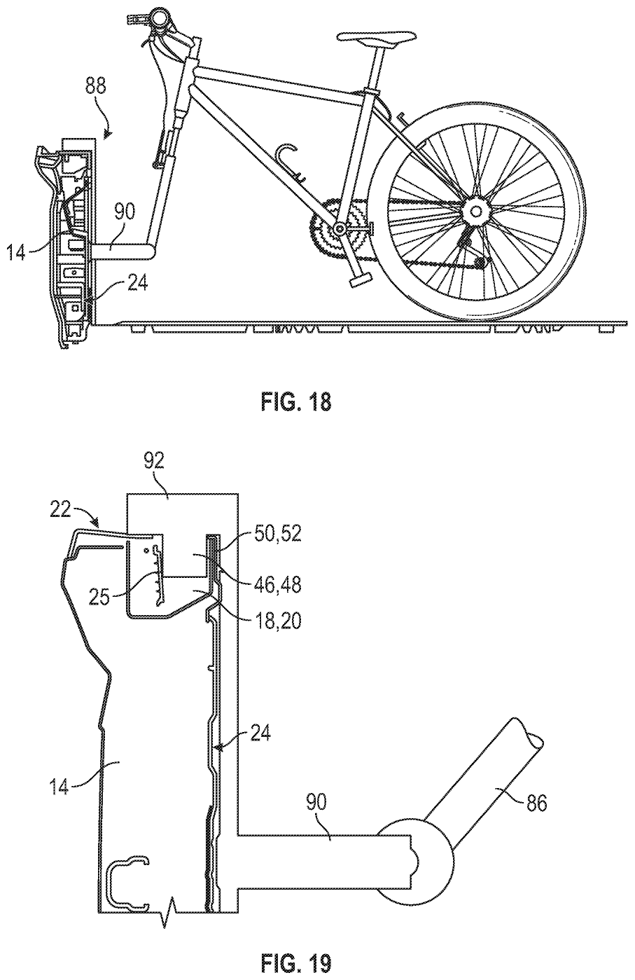

Referring to FIGS. 18 and 19, another example bike rack 88 includes a post 90 that extends horizontally outward from the surface 24 of the tailgate 14. The example bike rack 88 includes a mount portion 92 with posts 46 and 48. From the mount portion 92, a portion of the bike rack extends downward along the interior surface 24 of the tailgate 14 and defines posts 90 while also protecting the interior of the tailgate 14 from any scratches from the bike mounted to the bike rack 88. The posts 90 extend horizontally outward into the cargo area 12 instead of above the tailgate 14 as was shown in the previous embodiment. In this example, the post 90 provides for securement of the front fork 86 of the bike to secure the bike within the cargo area 12.

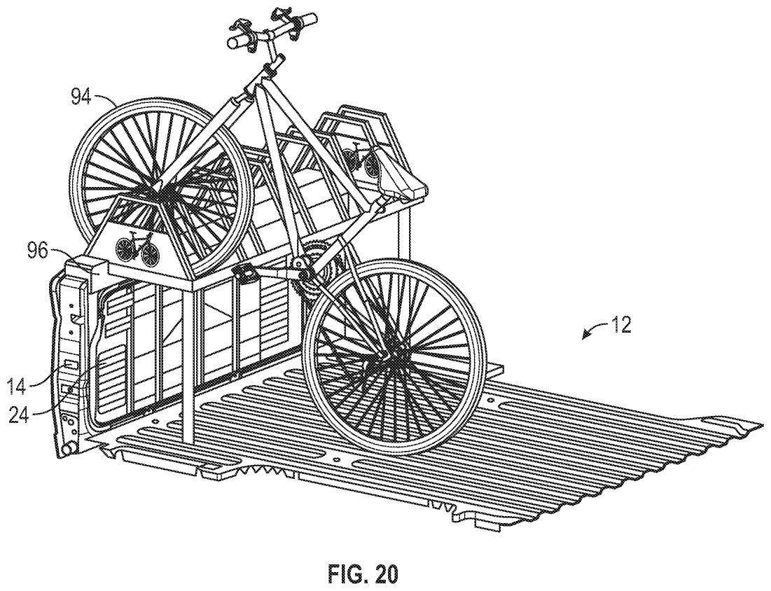

Referring to FIG. 20, another bike rack embodiment is disclosed and is schematically shown at 94. The bike rack 94 includes the mount portion 96 with the posts 46 and 48 as previously disclosed and described. In this example, the bike rack 94 facilitates securement of the bike along the top surface of the tailgate 14 with the front fork of the bike frame attached to the bike rack that can be used in combination with a bike locking chain that can be secured to the bike rack. In an alternative embodiment, the wheel may remain in place with the fork attachment of the bike rack removed from the design of the bike rack allowing the front wheel to secure to the bike rack bars.

Accordingly, the disclosed example accessory items include standard post features that correspond with openings within the tailgate to enable mounting and securement to the vehicle tailgate. Although several different accessory items are disclosed by way of example, other accessory items configured with the example mount portion are within the contemplation and scope of this disclosure.

Although the different non-limiting embodiments are illustrated as having specific components or steps, the embodiments of this disclosure are not limited to those particular combinations. It is possible to use some of the components or features from any of the non-limiting embodiments in combination with features or components from any of the other non-limiting embodiments.

It should be understood that like reference numerals identify corresponding or similar elements throughout the several drawings. It should be understood that although a particular component arrangement is disclosed and illustrated in these exemplary embodiments, other arrangements could also benefit from the teachings of this disclosure.

The foregoing description shall be interpreted as illustrative and not in any limiting sense. A worker of ordinary skill in the art would understand that certain modifications could come within the scope of this disclosure. For these reasons, the following claims should be studied to determine the true scope and content of this disclosure.

What is claimed is:

1. A tailgate accessory assembly comprising:
an accessory body portion;
a first post spaced a distance from a second post, wherein each of the first post and second post configured for insertion into corresponding openings in a tailgate; and
a clip for engaging a portion of the tailgate in a locked position for holding the accessory body portion to the tailgate.

2. The tailgate accessory assembly as recited in claim 1, including a mount portion attached to the body portion and the first post and the second post extend from the mount portion, the mount portion abutting a surface of the tailgate when the clip is in the locked position.

3. The tailgate accessory assembly as recited in claim 2, wherein the first post and the second post are identically shaped.

4. The tailgate accessory assembly as recited in claim 3, wherein the first post and the second post are disposed within a common plane.

5. The tailgate accessory assembly as recited in claim 2, wherein the clip comprises a first clip disposed adjacent the first post and a second clip disposed adjacent the second post.

6. The tailgate accessory assembly as recited in claim 2, including an electrical connector for connecting to a power source.

7. The tailgate accessory assembly as recited in claim 2, wherein the accessory body portion comprises a storage box including an interior space covered by a lid.

8. The tailgate accessory assembly as recited in claim 7, wherein the mount portion is disposed transverse to the storage box such that the storage box rests on an inside surface of the tailgate.

9. The accessory assembly as recited in claim 2, wherein the accessory body portion comprises a storage container with a closeable lid, the closeable lid including one of a high persistent phosphor warning sign or an illuminable warning sign.

10. The accessory assembly as recited in claim 2, wherein the accessory body portion comprises an ice chest having a compartment for ice.

11. The accessory assembly as recited in claim 10, wherein the first post and the second post extend outward transverse to the compartment for supporting the ice chest with the tailgate in a closed position.

12. The accessory assembly as recited in claim 10, wherein the first post and the second post extend outward parallel to the compartment for supporting the ice chest with the tailgate in an opened position.

13. The accessory assembly as recited in claim 10, wherein the ice chest includes a shelf extending from an outer surface of the compartment.

14. The accessory assembly as recited in claim 10, including cup holders that are supported within the compartment.

15. The accessory assembly as recited in claim 10, including a cooling assembly for cooling the compartment, the cooling assembly powered by an electrical connection to a power source.

16. The accessory assembly as recited in claim 2, wherein the accessory body portion comprises a work table extending outward from the tailgate, the work table including a support member, an electrical power outlet and light source connectable to a power source.

17. The accessory assembly as recited in claim 2, wherein the accessory body portion comprise a bike rack for securing a bike to the tailgate.

18. The accessory assembly as recited in claim 17, wherein the bike rack includes a post for securement of a portion of a bike.

19. The accessory assembly as recited in claim 18, wherein the post extends upward from a top surface of the tailgate when the tailgate is in a closed position.

20. The accessory assembly as recited in claim 18, wherein the post extends transversely from an inner surface of the tailgate when the tailgate is in a closed position.
